(19) United States
(12) Patent Application Publication
(10) Pub. No.: US 2002/0149936 A1
(43) Pub. Date: Oct. 17, 2002

(54) Decorative lighting assembly

(76) Inventors: Alfred M. Mueller, Ft. Myers Florida, FL (US); Laura G. Barrow, Estero, FL (US)

Correspondence Address: Laura G. Barrow, Esq., P.O. Box 215, Estero, FL, 33928-0215, US

(21) Appl. No.: 09/835,114

(22) Filed: Apr. 13, 2001

(51) Int. Cl. F21V 21/00

(52) U.S. Cl. 362/249

(57) ABSTRACT

A novel decorative lighting assembly is disclosed comprising, in certain embodiments, a strand of light bulbs engaged within light bulb sockets. The light bulb socket comprises a clip that is permanently affixed or integrally molded to the exterior surface of the socket. The clip is configured to engage a portion of complementarily configured fixture, such as an ornamental wire display, a building, or tree, for example.

### BACKGROUND AND SUMMARY OF THE INVENTION

The present invention is directed to a novel decorative lighting assembly suitable for attachment to a variety of fixtures, including buildings, ornamental displays, and trees. Current decorative lighting systems for attachment to building exteriors, ornamental fixtures, such as wire sculptures, for example, and shrubbery, including Christmas trees, comprise a string of spaced apart light bulb sockets attached by some means to the building exterior or ornamental fixture. Engaged within each light bulb socket is a decorative light bulb. The “string” comprises one or more strands of electrical wiring having two plug ends for engaging additional strands of wiring and for engaging a power source to illuminate the bulbs.

Various means for securing such decorative lighting systems to building exteriors, for example, include engaging the socket, light bulb, or strand of wiring within a separate clip or bracket that has been previously secured to the building exterior by means of staples or nails, for example. Similarly, for ornamental fixtures, such as wire sculptures typically displayed on front lawns during holidays, the strand of wiring, light bulb socket, or light bulb is secured to the fixture by separate clips or brackets that have been previously secured to the fixture. For decorating large buildings or multiple ornamental fixtures, for example, the placement of several strands of lights can be quite time-consuming, especially when separate attachment brackets or clips must first be arranged on the building or fixture prior to attachment of the light string.

The present invention is directed to a decorative lighting assembly that in some applications is more convenient to use and allows for faster attachment of the light string to the desired object. Specifically, the decorative lighting assembly of the present invention, in certain aspects, comprises a light bulb socket secured to a strand of electrical wiring by a clip that is integrally molded to the socket, thereby obviating the need in some applications for prior attachment of separate clips or brackets to fixtures that already have areas conducive to attachment by the clips, as discussed in more detail below.

### BRIEF DESCRIPTION OF THE FIGURES

FIG. 1 is a side view of one embodiment of the present invention.

FIG.. 1a is a side view of the socket shown in FIG. 1 without the light bulb.

FIG. 2 is a perspective view of the embodiment shown in FIG. 1.

FIG. 2a is a side view of the socket taken along lines 2a-2a of FIG. 1a.

FIG. 3 is a front end view taken along lines 3-3 of FIG. 1.

FIG. 4 is a perspective view of second embodiment of the present invention.

FIG. 5. is a side view of the embodiment shown in FIG. 4.

FIG. 6 is a front end view taken along lines 6-6 of FIG. 5.

FIG. 7 is a side view of embodiment shown in FIG. 1 attached to a fixture.

FIG. 8 is a side view of embodiment shown in FIG. 4 attached to a fixture.

FIG. 9 is a side view of a string of the combination light bulb socket, light bulb, and clip.

### DETAILED DESCRIPTION OF THE PREFERRED EMBODIMENTS

The current invention is directed to an improved decorative lighting assembly that, in certain aspects, provides for a faster and more convenient means for attaching the lighting assembly to a desired fixture.

Referring now to the figures, the decorative lighting assembly of the present invention, designated generally as “10,” comprises a light bulb socket 11 having an open end 12 (FIG. 2a) in communication with an inner chamber 13 (FIG.. 1a) for receiving a light bulb 14 therein. The socket 11 further has a base portion Ha to which a strand 20 of electrical wiring is secured. As illustrated in FIG. 9, the strand of wiring terminates into an electrical plug 21 for attachment to another strand of wiring or an electrical power source. A plurality of sockets 11 may be secured to one another along the strand of electrical wiring (FIG. 9). The inner construction and electrical operation of the light bulb socket and wiring are the same as for any conventional light bulb socket now known by the skilled artisan or later developed.

Secured to the light bulb socket 11 is a clip 30. The clip 30 is configured to engage a complementarily configured portion of a fixture F, thereby securing the light bulb socket 11 to the fixture F. As used herein, “fixture” includes, but is not limited to, the following: (a) any portion of a building exterior or interior to which the clip may be secured, such as the edge of a rain gutter or a separate rod or bracket attached to the building exterior or interior; (b) trees wherein the clip engages a branch, for example (as used herein, “tree” further includes shrubbery and other similar plants); (c) ornamental displays, such as metal or plastic wire sculptures commonly displayed on lawns (e.g. wire deer sculptures, wire angel sculptures, and the like), for example, wherein the clip directly engages the “wire” forming the sculpture; and (d) any other object that has an area of attachment conducive for the engagement of the clip.

The socket and clip may be formed of any conventional material currently used (or later developed for use) in the fabrication of light bulb sockets in decorative lighting systems. Preferably, both the socket and clip are formed of a molded plastic, wherein the clip 30 is integrally molded to the external surface of the socket 11. Alternatively, the clip may be permanently affixed to the external surface of the socket by means of a permanent adhesive substance.

The clip 30 is preferably semi-circular (i.e. U-shaped or C-shaped) in configuration, as shown in the figures, with the closed end 31 of the clip being permanently affixed, or integrally molded, to the socket. The configuration of the clip defines an inner channel 32 within which a complementarily shaped portion of the fixture is engaged. The two sides 33 of the clip are resiliently configured such that when the clip is pushed onto a rod or wire of a fixture, for example, for engagement therein, the clip sides 33 move apart slightly to allow the rod or wire to snap into place within the inner channel 32. While the semi-circular configuration of the clip, as shown, is preferred, it will be readily appreciated that the clip of the present invention may have different configurations in order to accommodate fixture structures having points of attachment that are not rounded or less rounded, for example.

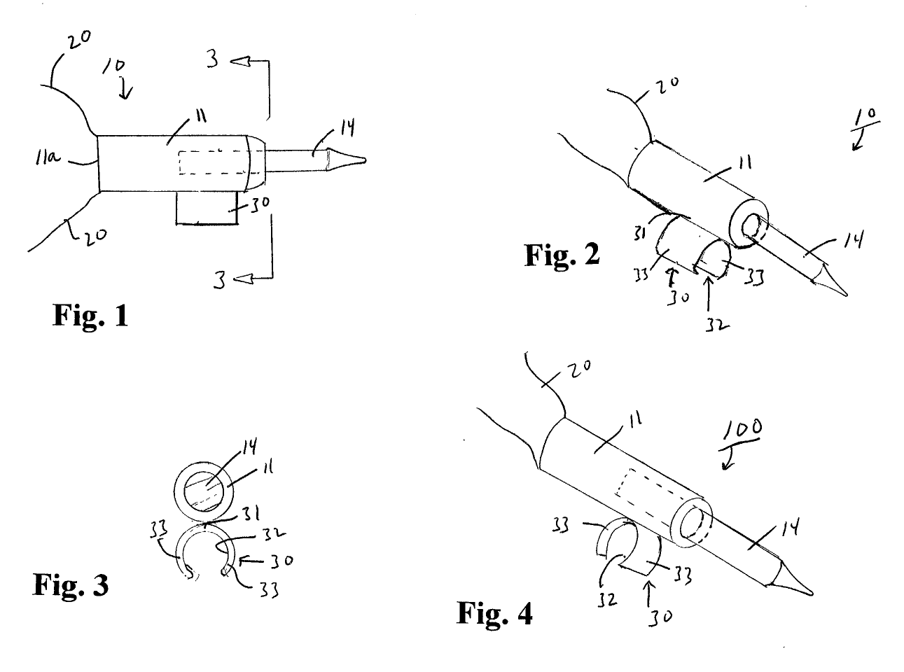

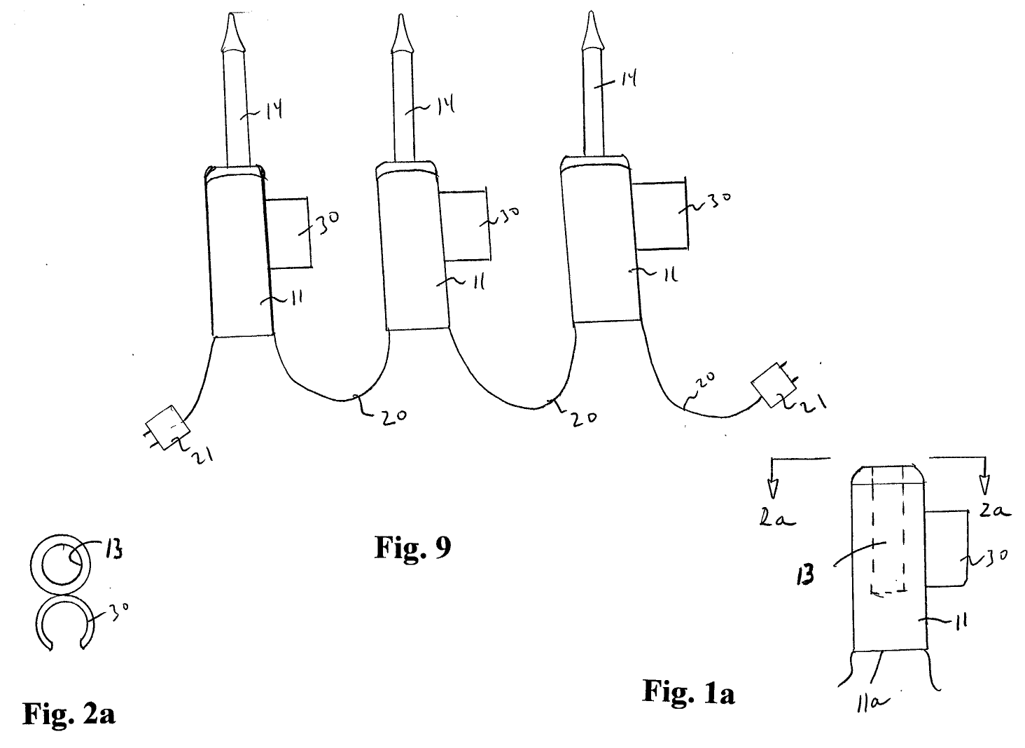

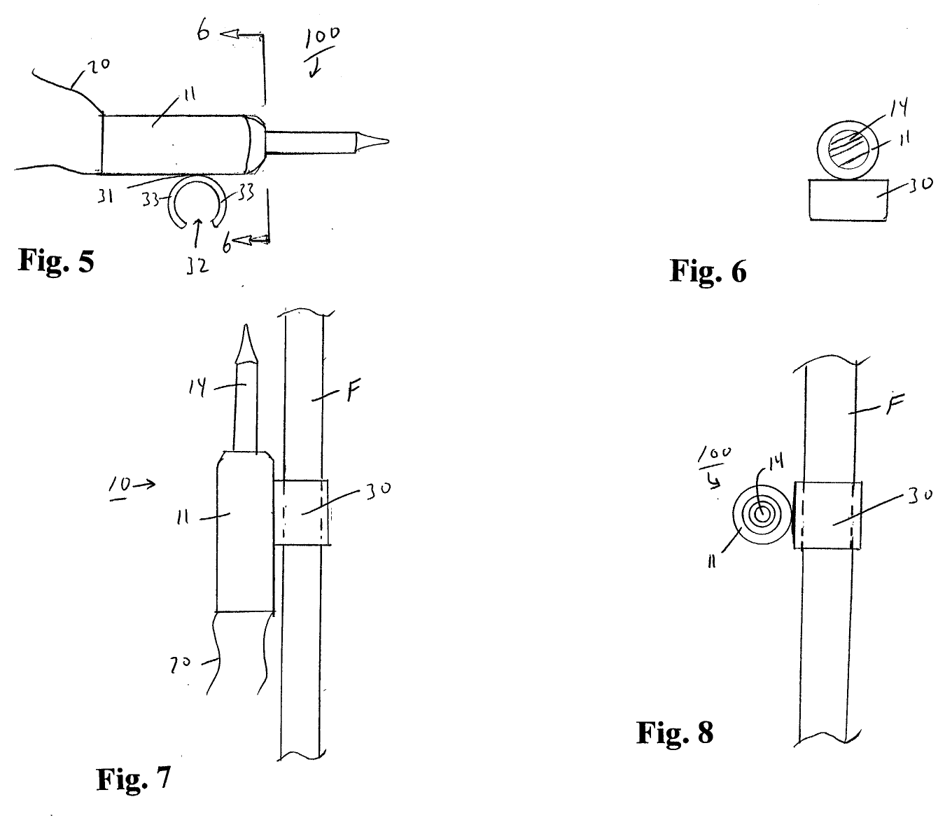

In certain embodiments, the clip 30 may be oriented as shown in FIGS. 1-3, and 7, wherein the inner channel 32 of the clip is in parallel alignment with the inner chamber 13 of the socket. Alternatively, the inventive decorative lighting assembly 100 may have a clip 30 may be oriented such that it is in perpendicular alignment with the inner chamber of the socket, as shown in FIGS. 4-6, and 8.

It will further be readily recognized and appreciated by those of ordinary skill in the art that the light bulb sockets and light bulbs of the present invention may be of any conventional type, preferably those that are employed in conventional decorative lighting systems, provided the socket is of sufficient size to accommodate the desired clip size.

The foregoing disclosure and description of the invention are illustrative and explanatory thereof, and various changes in the size, shape, and materials, as well as in the details of the illustrated construction may be made without departing from the spirit of the invention, and therefore fall within the scope of the appended claims even though such variations were not specifically discussed above.

I claim:

1. A decorative lighting assembly comprising:
a. a light bulb socket having an open end in communication with an inner chamber for receiving a light bulb;
b. a light bulb engaged within said inner chamber of said socket;
c. a strand of electrical wiring secured to said socket for illuminating said light bulb; and
d. a clip integrally molded to said socket, said clip adapted to engage a portion of a fixture, thereby securing said socket to said fixture.

2. The decorative lighting assembly of claim 1, wherein said fixture is an ornamental wire display.

3. The decorative lighting assembly of claim 1, wherein said fixture is a portion of a building.

4. The decorative lighting assembly of claim 1, wherein said fixture is a tree.

5. The decorative lighting assembly of claim 1, said clip having a semi-circular configuration that defines an inner channel within which said portion of said fixture is engaged, said channel oriented in parallel alignment with respect to said inner chamber of said socket.

6. The decorative lighting assembly of claim 5, wherein said fixture is an ornamental wire display.

7. The decorative lighting assembly of claim 5, wherein said fixture is a portion of a building.

8. The decorative lighting assembly of claim 5, wherein said fixture is a tree.

9. The decorative lighting assembly of claim 1, wherein said inner channel of said clip is oriented perpendicularly with respect to said inner chamber of said socket.

10. The decorative lighting assembly of claim 9, wherein said fixture is an ornamental wire display.

11. The decorative lighting assembly of claim 9, wherein said fixture is a portion of a building.

12. The decorative lighting assembly of claim 9, wherein said fixture is a tree.

13. A decorative light assembly comprising:
a. a plurality of light bulb sockets, each of said sockets having an open end in communication with an inner chamber for receiving a light bulb;
b. a light bulb engaged within said inner chamber of each of said sockets;
c. a strand of electrical wiring secured to each of said sockets for illuminating said light bulb therein, said strand further having two opposing electrical prongs for connecting to an external power source or to additional strands of wiring; and
d. a clip integrally molded to each of said plurality of sockets, said clip adapted to engage a portion of a fixture, thereby securing said socket to said fixture.

14. The decorative lighting assembly of claim 13, wherein said fixture is an ornamental wire display.

15. The decorative lighting assembly of claim 13, wherein said fixture is a portion of a building.

16. The decorative lighting assembly of claim 13, wherein said fixture is a tree.

17. The decorative lighting assembly of claim 13, said clip having a semi-circular configuration that defines an inner channel within which said portion of said fixture is engaged, said channel oriented in parallel alignment with respect to said inner chamber of said socket.

18. The decorative lighting assembly of claim 17, wherein said fixture is an ornamental wire display.

19. The decorative lighting assembly of claim 17, wherein said fixture is a portion of a building.

20. The decorative lighting assembly of claim 17, wherein said fixture is a tree.

21. The decorative lighting assembly of claim 13, wherein said inner channel of said clip is oriented perpendicularly with respect to said inner chamber of said socket.

22. The decorative lighting assembly of claim 21, wherein said fixture is an ornamental wire display.

23. The decorative lighting assembly of claim 21, wherein said fixture is a portion of a building.

24. The decorative lighting assembly of claim 21, wherein said fixture is a tree.

25. A decorative lighting assembly comprising:
a. a light bulb socket having an open end in communication with an inner chamber for receiving a light bulb;
b. a light bulb engaged within said inner chamber of said socket;
c. a strand of electrical wiring secured to said socket for illuminating said light bulb; and
d. a clip permanently affixed to said socket, said clip adapted to engage a portion of a fixture, thereby securing said socket to said fixture.

26. The decorative lighting assembly of claim 25, wherein said fixture is an ornamental wire display.

27. The decorative lighting assembly of claim 25, wherein said fixture is a portion of a building.

28. The decorative lighting assembly of claim 25, wherein said fixture is a tree.

29. The decorative lighting assembly of claim 25, said clip having a semi-circular configuration that defines an inner channel within which said portion of said fixture is engaged, said channel oriented in parallel alignment with respect to said inner chamber of said socket.

30. The decorative lighting assembly of claim 29, wherein said fixture is an ornamental wire display.

31. The decorative lighting assembly of claim 29, wherein said fixture is a portion of a building.

32. The decorative lighting assembly of claim 29, wherein said fixture is a tree.

33. The decorative lighting assembly of claim 25, wherein said inner channel of said clip is oriented perpendicularly with respect to said inner chamber of said socket.

34. The decorative lighting assembly of claim 33, wherein said fixture is an ornamental wire display.

35. The decorative lighting assembly of claim 33, wherein said fixture is a portion of a building.

36. The decorative lighting assembly of claim 33, wherein said fixture is a tree.

37. A decorative light assembly comprising:
a. a plurality of light bulb sockets, each of said sockets having an open end in communication with an inner chamber for receiving a light bulb;
b. a light bulb engaged within said inner chamber of each of said sockets;
c. a strand of electrical wiring secured to said socket for illuminating said light bulb therein, said strand further having two opposing electrical plugs for connecting to an external power source or to additional strands of wiring; and
d. a clip permanently affixed to each of said plurality of sockets, said clip adapted to engage a portion of a fixture, thereby securing said socket to said fixture.

38. The decorative lighting assembly of claim 37, wherein said fixture is an ornamental wire display.

39. The decorative lighting assembly of claim 37, wherein said fixture is a portion of a building.

40. The decorative lighting assembly of claim 37, wherein said fixture is a tree.

41. The decorative lighting assembly of claim 37, said clip having a semi-circular configuration that defines an inner channel within which said portion of said fixture is engaged, said channel oriented in parallel alignment with respect to said inner chamber of said socket.

42. The decorative lighting assembly of claim 41, wherein said fixture is an ornamental wire display.

43. The decorative lighting assembly of claim 41, wherein said fixture is a portion of a building.

44. The decorative lighting assembly of claim 41, wherein said fixture is a tree.

45. The decorative lighting assembly of claim 37, wherein said inner channel of said clip is oriented perpendicularly with respect to said inner chamber of said socket.

46. The decorative lighting assembly of claim 45, wherein said fixture is an ornamental wire display.

47. The decorative lighting assembly of claim 45, wherein said fixture is a portion of a building.

48. The decorative lighting assembly of claim 45, wherein said fixture is a tree.
